(19) United States
(12) Patent Application Publication
(10) Pub. No.: US 2020/0400286 A1
(43) Pub. Date: Dec. 24, 2020

(54) CONSTRUCTION OF ROTATIONAL PREFERENCE DURING LAMP VIBRATION

(71) Applicant: SIGNIFY HOLDING B.V., EINDHOVEN (NL)

(72) Inventors: JOHANNES GERRIT JAN BEIJER, BAVEL (NL); VINCENT STEFAN DAVID GIELEN, GASTEL (NL)

(21) Appl. No.: 16/977,094

(22) PCT Filed: Feb. 28, 2019
(86) PCT No.: PCT/EP2019/054962

§ 371 Date: Sep. 1, 2020

(30) Foreign Application Priority Data
Mar. 13, 2018 (EP) 18161490.0

(51) Int. Cl. F21V 15/04; F21V 19/04

(52) U.S. Cl. CPC F21V 15/04; F21V 19/04

(57) ABSTRACT

The invention provides a rotator element (1200) for e.g. a screw cap of a lighting device, wherein the rotator element (1200) is rotatable in first direction, wherein the rotator element (1200) comprises a movable element (310) which is at least movable in a plane parallel to the first rotation direction, wherein the movable element (310) is configured to exert a torque in the same direction as the first rotation direction when a vibration in a plane parallel to the first rotation direction is applied to the rotator element (1200).

### FIELD OF THE INVENTION

The invention relates to a rotator element and a rotation-based mount comprising such rotator element, for a lighting device. The invention also relates to a lighting device comprising such rotator element or such rotation-based mount. Yet further, the invention also relates to a luminaire or outdoor lighting system comprising such lighting device.

### BACKGROUND OF THE INVENTION

Shock absorption systems are known in the art. EP2743574, for instance, describes a lighting apparatus including a body having a first mounting part, a second mounting part, a first coupling part and a second coupling part, a light source unit provided on the first mounting part of the body, a shock absorption assembly disposed on each of the second mounting parts provided on respective opposite ends of the body, a first fastening member coupled to the first coupling part of the body to fasten the light source unit to the body, a second fastening member coupled to each of the second coupling part of the body to fasten the corresponding shock absorption assembly to the body, and a mounting means for fastening the body to an installation target, wherein the shock absorption assembly includes a connector having a fastening part, and a shock absorption member interposed between the connector and the second fastening member.

### SUMMARY OF THE INVENTION

For many lamp designs going from conventional (incandescent, UHP, CDM etc.) towards LED replacement, the weight of the LED lamp may be larger than that of the original lamp. As a result, the forces on the lamp holder will be much larger, especially due to dynamic loading/vibrations. Therefore the friction forces between the lamp holder and the lamp cap can be overcome and therefore the lamp can gradually turn out of its (matching) socket.

Shock absorption systems known in the art do not solve this problem. Hence, it is an aspect of the invention to provide an alternative lighting device or part thereof, which preferably further at least partly obviate(s) one or more of above-described drawbacks. The present invention may have as object to overcome or ameliorate at least one of the disadvantages of the prior art, or to provide a useful alternative.

In a first aspect, the invention provides a rotator element that is rotatable in first direction, wherein the rotator element comprises a movable element which is at least movable in a plane parallel to the first rotation direction, wherein the movable element is configured to exert a torque in the same direction as the first rotation direction when a vibration in a plane parallel to the first rotation direction is applied to the rotator element. Such rotator element may e.g. include a ring-shaped element which comprises the movable element or to which the movable element is functionally coupled. Such rotator element may be functionally coupled to a lighting device that includes a rotation-based mount. Especially, in embodiments the rotator element may be comprised in a rotation-based mount (“mount”) for e.g. a lighting device, such as within a screw cap of the rotation-based mount.

Hence, in a further aspect, the invention provides a rotation-based mount for a lighting device, the rotation-based mount configured to be mounted in a matching socket via a rotation in a first rotation direction of the rotation-based mount in the matching socket, wherein the rotation-based mount comprises a movable element which is at least movable in a plane parallel to the first rotation direction, wherein especially the movable element is configured to exert a torque in the same direction as the first rotation direction when a vibration in a plane parallel to the first rotation direction is applied to the rotation-based mount.

Therefore, in an aspect the invention also provides a rotation-based mount for a lighting device, wherein the rotation-based mount comprises the rotator element as defined herein, wherein the rotation-based mount is configured to be mounted in a matching socket via a rotation in the first rotation direction of the rotation-based mount in the matching socket, wherein the movable element is configured to exert a torque in the same direction as the first rotation direction when a vibration in a plane parallel to the first rotation direction is applied to the rotation-based mount.

In yet a further aspect, the invention provides a lighting device comprising (i) the rotator element as defined herein and a rotation-based mount, or (ii) the rotation-based mount as defined herein (i.e. including the rotator element), wherein the rotation-based mount is configured to be mounted in a matching socket via a rotation in a first rotation direction of the rotation-based mount in the matching socket. Hence, in yet a further aspect the invention also provides a lighting device comprising the rotation-based mount as defined herein, wherein the rotation-based mount is configured to be mounted in a matching socket via a rotation in a first rotation direction of the rotation-based mount in the matching socket. The invention also provides a lighting device wherein the rotator element is functionally coupled to the outside of the rotation-based mount, or to the lighting device but not necessarily the mount.

Herein, the term “rotator element” may also refer to a plurality of (different) rotator elements. For instance, the lighting device may comprise one rotator element, but may in principle also comprise two or more rotator elements.

With such rotator element (or rotation-based mount with such rotator element), vibrations that may otherwise lead to loosening and finally to a complete loosening of the rotator element, may now promote strengthening as the rotator element may be inclined to rotate in the direction of a press fit or may prevent rotating in a counter direction. Especially, with such mount vibrations that may otherwise lead to loosening and finally to a complete loosening of the mount from the socket, may now promote strengthening of the connection between the mount and socket. Instead of the term “rotator element” also the term “rotatable element” may be applied. The rotator element especially comprises a rotator element part. This may e.g. a ring, though other shapes may also be possible. Especially the movable element is movable relative to this rotator element part. Hence, the movable element is at least movable, relative to the rotator element part, especially in a plane parallel to the first rotation direction. The movement may e.g. be a rotation or a translation.

As indicated above, the rotation-based mount configured to be mounted in a matching socket via a rotation in a first rotation direction of the rotation-based mount in the matching socket. Especially, the mount is an Edison cap or Edison screw or similar mount. Examples thereof are e.g. the E10 Miniature (Flashlight lamp), E11 Mini-Candelabra, E12 Candelabra, E14 European, E11 Intermediate, E26 Medium, E27 Medium, E39 Mogul, E40 Mogul, 3-Way (modified medium or mogul socket with additional ring contact for 3-way lamps), and Skirted (PAR-38). Further information may e.g. be found in ANSI C81.61-2016 American National Standard for Electrical Lamp Bases. The rotator element or rotation-based mount with such rotator element may especially be used for lighting devices, but may alternatively also be used in or for other devices with a rotation-based mount.

In general, such mounts include a right-hand threaded metal base (cap) which screw into a matching threaded sockets (lamp holders). Hence, such mount can be fixed into a socket by a (right) rotation e.g. until a (kind of) interference fit, also known as a press fit or friction fit, is obtained. Hence, in embodiments the rotation-based mount may include a screw cap for arranging the lighting device (or other device) in a matching socket. This also allows an arrangement of the rotator element such that it is not visible from the outside when viewing the rotation-based mount from the outside, such as perpendicular to an axis or rotation or mount axis. Hence, in embodiments a lamp or a luminaire is provided, wherein the rotator element is configured within a screw cap of the lighting device. However, the rotator element may also be attached to the screw cap, or to another part of the lighting device.

Hence, the rotator element may be configured in different parts of the lighting device, or other device. In embodiments, the rotator element may also be comprised by a lighting device comprising a carrier part, wherein the carrier part e.g. comprises one or more of a driver and a controller (or control system). Hence, in specific embodiments the lighting device may comprise the rotation-based mount, a light transmissive envelope, and a carrier part, wherein the carrier part is functionally coupled to the rotation-based mount and the light transmissive envelope, wherein the carrier part comprises the rotator element. For instance, the carrier part may be configured between the mount including the screw cap and at least part of the envelope. The envelope may partially be configured in the carrier part.

Especially, the rotator element is invisible from the outside of the lighting device (or other device). For instance, the rotator element may be configured within the screw cap, or the rotator element may be configured within the carrier part (see also above). The rotator element may be included in a (closed) housing, by which the rotator element may not be visible from external of the device.

Amongst others, the invention proposes some mechanical constructions that cause the torsional (inertia) forces to be higher in one rotational direction than in the other rotational direction. This force asymmetry can be chosen such that during vibration of the lamp, the forces will first overcome the frictional forces that prevent the lamp for further screwing in. Therefore, the lamp will have a rotation preference for further screwing in the socket when vibrations occur. In embodiments, the constructions proposed comprise weights that will give a hard collision in one direction will giving a soft collision in the other direction. The hard collision will yield a large (short) force while the soft collision will yield a smaller (but longer) force. This is used to result in the rotational preference.

Hence, especially the rotator element, such as the rotation-based mount, comprises a movable element which is at least movable in a plane parallel to the first rotation direction. This may allow a conversion of a shock, or a plurality of shocks perpendicular to an axis of rotation, such as a mount axis, to be converted in a force that promotes rotation of the rotator element. Especially, this may allow a conversion of a shock, or a plurality of shocks perpendicular to an axis of rotation, such as a mount axis, to be converted in a force that promotes rotation of the rotation-based mount into the socket instead of rotation of the mount out of the socket. Hence, especially the movable element is configured to exert a torque in the same direction as the first rotation direction when a vibration in a plane parallel to the first rotation direction is applied to the rotation-based mount. Especially, the moveable element is configured to exert a torque on the rotator element with respect to an axis of rotation (perpendicular to a plane wherein the movable element may move) in the same direction as the first rotation direction when a vibration in a plane parallel to the first rotation direction is applied to the rotator element.

Herein, the term “vibration” may refer to a mechanical shock or a plurality of mechanical shocks, such as may e.g. be the case for a lamp in an outdoor lamp pole, or a lamp in a transportation vehicle, such as a car, etc.

Especially, the movable element comprises a mass, such as a ball, of relative hard material, such as ceramic and/or metal. Hence, the movable element especially comprises a mass of a rigid material. For instance, in embodiments the moveable element may comprise a ceramic or metal ball, or optionally of another rigid material. Hence, the mass may have a relative high Young's modulus of elasticity.

The term “movable element” may in embodiments also refer to a plurality of (different) movable elements. Hence, the rotator element, such as a mount comprising the rotator element, may comprise a plurality of movable elements. Further, the term “rotator element part” may also refer to a plurality of rotator element parts. For instance, there is a plurality of sets of each a rotator element part and an (associated) movable element.

The mount may comprise a mount axis. This mount axis may essentially coincide with an axis of rotation (of the rotator element and/or the lighting device). The mount axis is (thus) especially configured perpendicular to a plane parallel to the first rotation direction. The phrase “plane parallel to the first rotation direction” may also refer to a plane, wherein the first rotation direction is in the plane. The rotation direction may be indicated with a curved arrow, which may thus be in the plane perpendicular to the axis of rotation or the mount axis.

As indicated above, the mount may include a plurality of movable elements. Therefore, in embodiments the rotator element, or especially the rotation-based mount, may comprise at least n movable elements. Especially, n may be two or larger, even more especially n may be three or larger, such as n being selected from the range of 3-24, such as especially selected from the range of 3-4. Further, the rotator element, such as the mount, may comprise n regions each comprising at least one of the movable elements. Especially, the n regions are rotationally symmetrically distributed around the axis of rotation or the mount axis. As indicated above, n may be two or larger, even more especially n may be three or larger, such as n being selected from the range of 3-24. Each region may thus include a movable element, though one or more regions may also include a plurality of movable elements. Using three or more regions may allow converting essentially any vibration having a force component perpendicular to the axis of rotation of the rotator element/mount axis of the rotation-based mount into a (net) force in the direction of the first rotation direction.

Such region may e.g. include a part of a rotator element part, such as a part of a mount part, with a movable element attached to the rotator element part, such as the mount part, with a movable arm. Alternatively or additionally, a region may be provided comprising a channel wherein the movable element can move. Also a single round region may be provided, wherein the movable element may move in preferentially one direction. The term “rotator element part” refers to a part of the rotator element. The rotator element part may e.g. comprise a ring-shaped element, such as ring. The rotator element part may also include a plurality of parts that are configured rotation symmetrical relative to an axis of rotation. Likewise, the term “mount part” refers to a part of the mount, which may (thus) e.g. comprise a ring-shaped element, such as ring.

Hence, in embodiments the movable element is attached to a rotator element part, such as a mount part, with a movable arm. Especially, the movable arm is flexible and/or rotatable (around a pivot point). Yet even more especially, a weight of the movable element is at least 2 times, especially at least 5 times, such as in the range of 5-50 times a weight of the movable arm. Hence, in embodiments the movable element is attached to a rotator element part, such as a mount part, with a movable arm. The mount part may e.g. be the cap or cap wall, or a ring included in the mount (or on the mount, or on a lighting device with such mount), etc. The movable arm provides the possibility to move the movable element, especially by a rotation along a pivot point. The rotation angle is especially smaller than 180°. The rotator element, such as the rotation-based mount, may further comprise a stop element rigidly associated with the rotator element part, such as rigidly associated with the rotator element part, such as the mount part, and configured at a position that when the movable element is subjected to a force in a direction of the first rotation direction, the movable element will exert a torque (with respect to an axis of rotation) on the stop element. Hence, a vibration induces a movement of the movable element in the direction of the stop element, which upon collision by the movable element receives a force in a direction of the rotation direction.

Hence, the stop element is especially also a hard element, such that maximum impact is obtained. The stop element may e.g. comprise metal or ceramic, or other rigid material, such as a rigid polymeric material. Hence, the stop element may (also) have a relative high Young's modulus of elasticity.

The flexible material, such as of a flexible stop element, may have e.g. a Young's modules which is at least 5 times, such as at least 10 times smaller than of the rigid material, such as of the mass and/or the rigid stop element (see also below).

When the movable element moves in an opposite direction, its energy should be used such that there is minimum force in a counter direction of the first rotation direction. The counter direction of the first rotation direction may also be indicated as second rotation direction of mount loosening rotation direction. The minimum impact of the movement of the movable element can be achieved by e.g. having the movable element apply a force in a direction perpendicular to the mount axis and/or by absorbing the force.

Therefore, in embodiments the moveable element and the movable arm are configured such that when the movable element is subjected to a force in a counter direction of the first rotation direction, the movable element will exert a force perpendicular to an axis of rotation, such as a mount axis, configured perpendicular to a plane parallel to the first rotation direction. This may e.g. be achieved in embodiments wherein the movable element may bounce on the rotator part, such as the mount part. Alternatively or additionally, the rotator element, such as the rotation-based mount may further comprise a flexible stop element rigidly associated with the rotator element part, such as the mount part, and configured at a position that when the movable element is subjected to a force in a counter direction of the first rotation direction, the movable element will exert a force on the flexible stop element. This may effectively imply a torque on the rotator element, such as the mount. However, due to the absorption of the force by the resilient material, due to the fact that a vibration also includes a back movement, the net torque on the mount may be larger in the first rotation direction. Hence, an interference fit is promoted and loosening of the mount in e.g. a socket may be prevented.

In yet other embodiments, the movable element may be able to move in a channel, but in one direction, i.e. in the direction of the first rotation, the movable element may meet at a rigid stop element and in the other direction, i.e. in a counter direction to the first rotation, the movable element meets a flexible stop element. Hence, in embodiments the rotator element, such as the rotation-based mount, may comprise a channel wherein the movable element can move in the first rotation direction and in a counter direction, wherein the channel has (i) a first end, wherein when the movable element moves in a direction of the first rotation direction, the movable element moves in the direction of the first end, and (ii) a second end, wherein when the movable element moves in a counter direction of the first rotation direction, the movable element moves in the direction of the second end, wherein the second end further comprises a flexible stop element. The flexible stop element may comprise a resilient material, such as e.g. rubber, or may comprise a spring element. The first end may especially comprise a rigid stop element (with a higher Young's modules than the flexible stop element; see also above).

In yet further embodiments, a ratchet-type system may be applied. Such system may allow movement in one direction, but may block movement in another direction. In the former situation, a movement in a counter direction of the first rotation direction may be absorbed by movement of the movable element, whereas in the latter situation a movement of the movable element in the direction of the first rotation direction may be blocked, by which effectively a torque to the mount may be applied in the direction of the first rotation direction.

Hence, in embodiments the rotator element, such as the rotation-based mount, may comprise a round channel configured rotationally symmetrically around the axis or rotation or mount axis, wherein the round channel and the moveable element comprises a ratchet system configured to hinder movement of the movable element in a direction of the first rotation direction and configured to allow movement of the movable element in a counter direction to the first rotation direction. As indicated above, the mount axis is especially configured perpendicular to a plane parallel to the first rotation direction. The term “round channel” especially refers to a continuous channel that is circumferential to the mount axis. The cross-sectional shape, perpendicular to a channel axis, may not necessarily be circular. Hence, the ratchet system may comprise a plurality of stop elements configured to hinder movement of the movable element in a direction. The phrase “configured to hinder” may especially indicate that the friction in the direction wherein the movement is hindered is substantially higher than in the counter direction. The term “hinder” may also refer to essentially blocking.

In a specific embodiment, the ratchet system may be comprised by an end cap, such that the lamp can rotate in the end cap in one direction (in the direction of screwing the lamp out) and not in the other direction (lamp screwing in). Additionally, one may use a blocking element to unmount the lamp from the socket. With this option, one may use moving elements with hard stops in both directions. The unscrewing stop may be made soft by the rotating end cap.

When using a plurality of movable elements, the chance is higher that a vibration may be converted in useful energy. As indicated above, especially when using three or more, essentially equally distributed moveable elements, may improve the effect. Hence, the above indicated embodiments with a round channel may also include a plurality of movable elements. Therefore, in embodiments the round channel comprises a plurality of moveable elements. Especially, the moveable elements may be connected via one or more (flexible) linking elements which also keep the moveable elements at a distance of each other. In this way, the movable elements may essentially be distributed equivalent-distant from each other. A kind of chain, with the movable elements, such as e.g. a kind of beads, may be able to move in essentially only one direction within the channel. When a plurality of movable elements is used in the same channel they may be coupled via a flexible linking element and/or may be magnetic, such that they repel each other.

Hence, in embodiments the linking element may be a (soft) spring or the like. In this way, fast movements of the individual elements are possible (and hence, when one of the movable element moves and e.g. an opposite movable element does not due to the ratchet, the last movable element gives rise to a torque moment). But on the long term upon many vibrations the elements are guaranteed not to stick together but keep separated. Alternatively or additionally, the elements may thus be magnetic such that they repel each other.

Phrases like “will exert a force” or “will exert a torque” and similar phrases especially refers to situation wherein the force applied to the movable element is such, that the movable element actually (after some movement) touches a stop element or other element on which then the force or torque is applied (relative to the axis or rotation). Of course, minor vibrations may not exert enough force to the movable element to finally reach the stop element or other element on which the force or torque is applied.

The lighting device comprises a light source. Especially, the lighting device is a solid state based lighting device. The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode, such as a passive-matrix (PMOLED) or an active-matrix (AMOLED). In a specific embodiment, the light source comprises a solid state light source (such as a LED or laser diode). In embodiments, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module. The term “light source” may also relate to a plurality of light sources, such as 2-2000 solid state light sources.

In yet a further aspect, the invention provides a lamp or a luminaire comprising the lighting device as defined herein, and a socket matching a rotation-based mount of lighting device, wherein the rotation-based mount (of the lighting device) is hosted by the socket. Hence, in yet a further aspect the invention also provides a luminaire comprising the lighting device as defined herein, and a socket matching the rotation-based mount of lighting device, wherein the rotation-based mount (of the lighting device) is hosted by the socket. Hence, in an aspect the invention further provides a lighting system comprising one or more of a lamp and a luminaire comprising the lighting device as defined herein, and a socket matching a rotation-based mount of the lighting device, wherein the rotation-based mount is hosted by the socket. Such lighting system may comprise a lamp comprising such lighting device, or comprising a plurality of such lighting devices. Such lighting system may also comprise a luminaire comprising such lighting device, or comprising a plurality of such lighting devices. Such lighting system may comprise a plurality of lamps. Such lighting system may also comprise a plurality of luminaires.

Such luminaire may be used in outdoor applications, or (other) heavy duty applications. Such luminaire may also be used in automotive applications, in industrial lighting etc. etc. Hence, in yet a further aspect, the invention provides for instance also an outdoor lighting system comprising the luminaire as defined herein. Other applications may also be possible. For instance, the lighting device may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, or LCD backlighting.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some embodiments and applications; and

FIGS. 2a-2f schematically depict some cross-sectional views (perpendicular to a mounting axis or axis of rotation) of embodiments of a mount, such as for instance may be used in the lighting device of FIG. 1a (or FIG. 1b).

The schematic drawings are not necessarily to scale. A single drawing may show a combination of different embodiments.

### DETAILED DESCRIPTION OF THE EMBODIMENTS

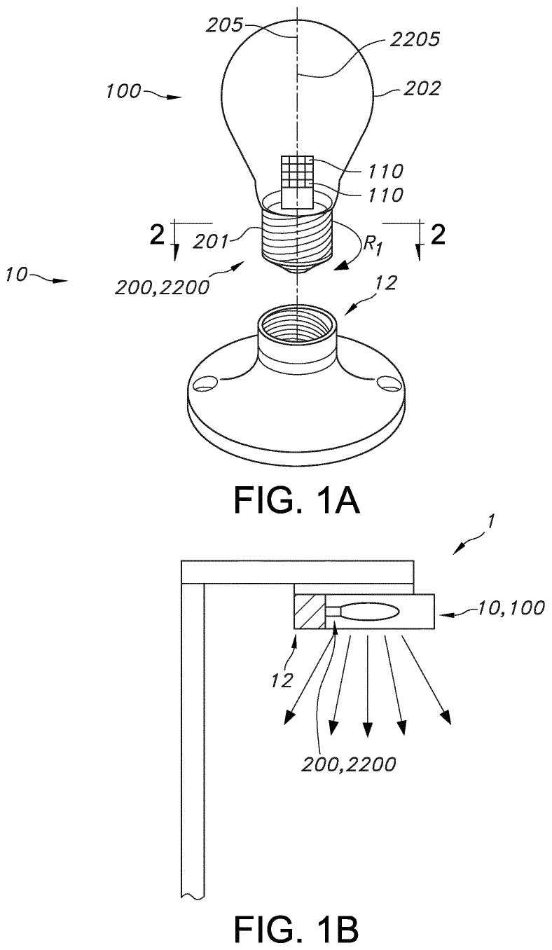

FIG. 1a schematically depicts an embodiment of a lighting device 100 comprising e.g. the rotation-based mount 200 as defined herein (i.e. including the rotator element). The rotation-based mount 200 is configured to be mounted in a matching socket 12 via a rotation in a first rotation direction of the rotation-based mount 200 in the matching socket. FIG. 1a schematically shows an embodiment wherein the lighting device comprises a plurality of light sources 110, such as solid state light sources, like LEDs. Hence, the lighting device 100 as schematically depicted is a solid state based lighting device. Reference 205 indicates a mount axis. This is an axis of rotation, which may also coincide with a socket axis not depicted, when mounted in the socket 12. Reference 201 indicates a screw cap, in general essentially of metal, for electrical conduction.

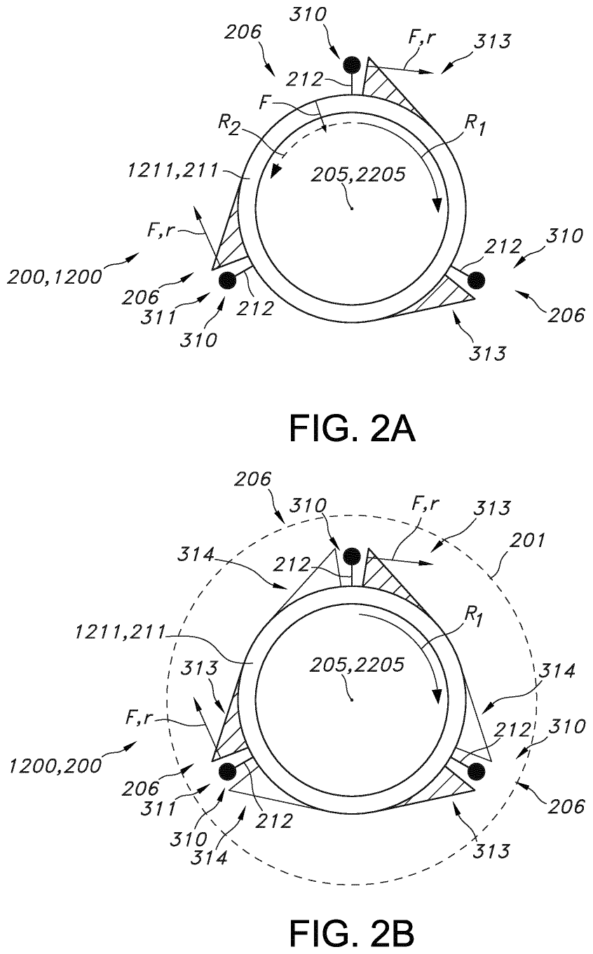

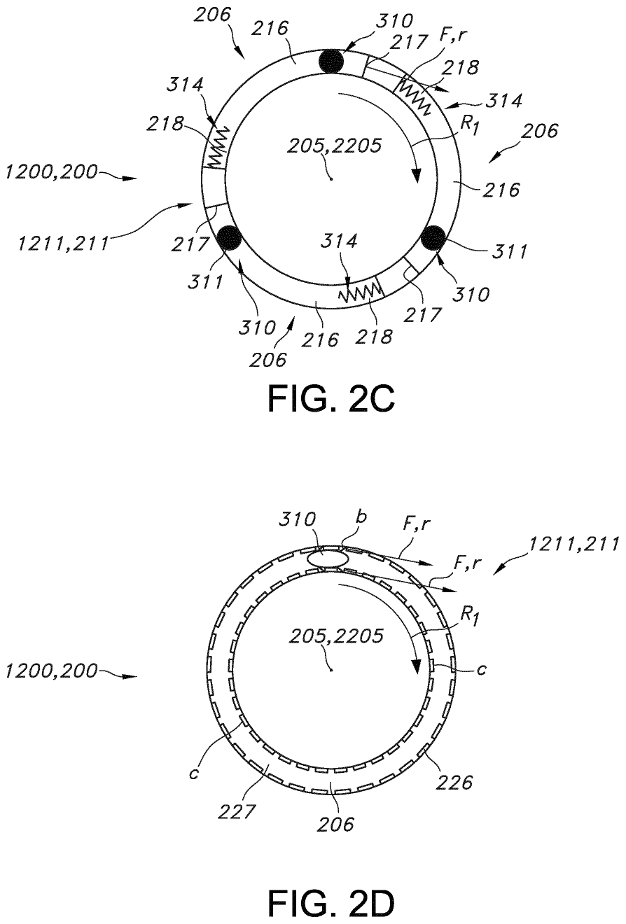

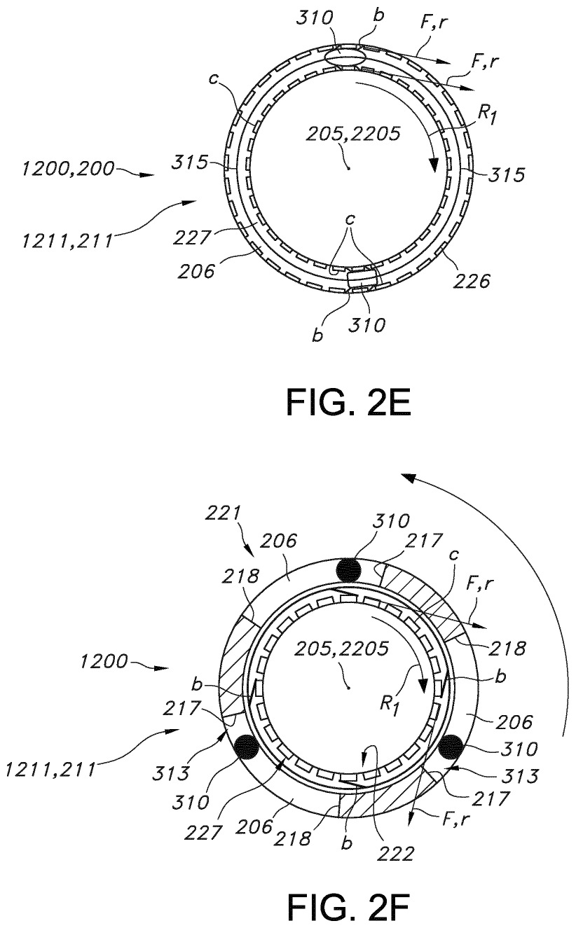

Reference 200 indicates the rotation-based mount. As in principle also other configurations of the rotator element (of which embodiments are schematically shown in FIGS. 2a-2f), i.e. not (only entirely) comprised by the end cap, may be possible, the mount shown in FIG. 1a may in principle also be a conventional mount, which is indicated with reference 2200. For instance, the rotator element, of which embodiments are shown in FIGS. 2a-2f, may be attached to the rotation-based mount. However, the rotator element may also be attached to the lamp itself (which on its turn is attached to the rotation based mount). Hence, the rotator element can be within the rotation-based mount, it can at the outside of such mount, and it may also be comprised in a functional coupling of the (remainder of the lamp) to the mount, etc. FIG. 1a especially depicts an embodiment wherein the rotator element is included in the end cap 201, i.e. the rotation-based mount is the rotation-based mount which is configured to be mounted in a matching socket via a rotation in a first rotation direction of the rotation-based mount in the matching socket, wherein the rotation-based mount comprises a movable element which is at least movable in a plane parallel to the first rotation direction, wherein especially the movable element is configured to exert a torque in the same direction as the first rotation direction when a vibration in a plane parallel to the first rotation direction is applied to the rotation-based mount.

In FIG. 1a, the lighting device 100 comprises a rotation based mount 200 or rotation based mount 2200 and a light transmissive envelope 202, which may be from glass, ceramic material, or other light transmissive material, for transmission of light of the one or more light sources 110. The lighting device may also include an intermediate part, which may also be indicated as carrier part, which may be configured between the mount and (at least part of) the light transmissive envelope. Such carrier part may include electronics. Such carrier part might also include the rotator element.

FIG. 1a also schematically depicts an embodiment of a luminaire 10 comprising the lighting device 100, and a socket 12 matching the rotation-based mount 200 of lighting device 100, wherein the rotation-based mount 200 is hosted by the socket 12. Here, for illustration purposes, the mount is not yet in the socket. By introducing the mount in the socket and rotation, in general clock-wise as depicted, an interference fit of the mount 200 in the socket 12 can be obtained. R1 indicates the first rotation direction, by which the mount 200 is configured into the socket 12.

In FIG. 1a, the rotator element is not visible from external of the lighting device 100. For instance, the mount 200 may thus host the rotator element. However, other embodiments are also possible, such as in a carrier part, on the mount, or even on the envelope 202 (especially close to the mount 2200, to minimize light losses).

FIG. 1b very schematically depicts an embodiment of an outdoor lighting system 1 comprising the luminaire 10. Such lighting system 1 may also comprise a plurality of such luminaires 10. The luminaire 10 comprises e.g. the lighting device 100 as defined herein.

FIG. 1b indicates that FIGS. 2a-2f may show cross-sectional views, with cross-sections perpendicular to the mount axis 205. This mount axis 205 and an axis or ration 2205 may essentially coincide.

FIGS. 2a-2f all show embodiments in cross-sectional views of a rotation-based mount 200 for a lighting device, the rotation-based mount 200 configured to be mounted in a matching socket via a rotation in a first rotation direction of the rotation-based mount 200 in the matching socket. The rotation-based mount 200 comprises a movable element 310 which is at least movable in a plane parallel to the first rotation direction, wherein the movable element 310 is configured to exert a torque in the same direction as the first rotation direction when a vibration in a plane parallel to the first rotation direction is applied to the rotation-based mount 200. The moveable element 310 comprises a mass, indicated with reference 311, which may be a ceramic ball or a metal ball, especially a mass of a relative rigid material. As shown, the rotation-based mount 200 comprises a mount axis 205 configured perpendicular to a plane parallel to the first rotation direction. Further, the rotation-based mount 200 comprises at least n movable elements 310, wherein the rotation-based mount 200 comprises n regions 206 each comprising at least one of the movable elements 310, wherein the n regions 206 are rotationally symmetrically distributed around the mount axis 205, and wherein n is at least 3.

FIG. 2a especially depicts an embodiment wherein the movable element 310 is attached to a rotator element part (1211), such as a mount part 211 with a movable arm 212, wherein the rotation-based mount 200 further comprises a stop element 313 rigidly associated with the rotator element part (1211), such as the mount part 211 and configured at a position that when the movable element 310 is subjected to a force in a direction of the first rotation direction, the movable element 310 will exert a torque (with respect to an axis of rotation 2205) on the stop element 313. This is schematically shown with the tangential arrow which may indicate a force or torque. The stop element 313 may be of a rigid material.

Hence, more in general FIG. 2a (and also FIGS. 2b-2f) schematically depict an embodiment(s) of a rotator element 1200 that is rotatable in first direction, wherein the rotator element 1200 comprises a movable element 310 which is at least movable in a plane parallel to the first rotation direction, wherein the movable element 310 is configured to exert a torque in the same direction as the first rotation direction when a vibration in a plane parallel to the first rotation direction is applied to the rotator element 1200.

As also shown in FIG. 2a, the moveable element 31 and the movable arm 212 may be configured such that when the movable element 310 is subjected to a force in a counter direction of the first rotation direction, the movable element 310 will exert a force perpendicular to an axis of rotation 2205, such as a mount axis 205 configured perpendicular to a plane parallel to the first rotation direction. This is shown with the dotted/dashed configuration, and the radial arrow indicating a force.

Hence, when the movable element 310 would hit the stop element 313, a force or torque is applied, by which the rotator element 1200 rotates in a direction R1.

FIG. 2b schematically shows an embodiment of the rotation-based mount 200, wherein the rotation-based mount 200 further comprises a flexible stop element 314 rigidly associated with the rotator element part 1211, such as the mount part 211 and configured at a position that when the movable element 310 is subjected to a force in a counter direction of the first rotation direction, the movable element 310 will exert a force on the flexible stop element 314.

FIG. 2b also schematically indicates with the dashed circular line that the rotatable element 1200 may be configured with a screw cap 201 of the rotation based mount 200. Reference 201 schematically indicates an embodiment of the screw cap.

Hence, more in general FIG. 2b also schematically depicts an embodiment of the rotator element 1200.

FIG. 2c schematically depicts an embodiment of the rotation-based mount 200, wherein rotation-based mount 200 comprises a channel 216 wherein the movable element 310 can move in the first rotation direction and in a counter direction, wherein the channel 216 has (i) a first end 217, wherein when the movable element 310 moves in a direction of the first rotation direction, the movable element 310 moves in the direction of the first end 217, and (ii) a second end 218, wherein when the movable element 310 moves in a counter direction of the first rotation direction, the movable element 310 moves in the direction of the second end 218, wherein the second end 218 further comprises a flexible stop element 314. More in general FIG. 2c also schematically depicts an embodiment of the rotator element 1200.

FIG. 2d schematically depicts an embodiment of the rotation-based mount 200, which comprises a mount axis 205 configured perpendicular to a plane parallel to the first rotation direction, wherein the rotation-based mount 200 comprises a round channel 226 configured rotationally symmetrically around the mount axis 205, wherein the round channel 226 and the moveable element 310 comprises a ratchet system 227 configured to hinder movement of the movable element 310 in a direction of the first rotation direction and configured to allow movement of the movable element 310 in a counter direction to the first rotation direction. Also, more in general FIG. 2d also schematically depicts an embodiment of the rotator element 1200.

FIG. 2e schematically depicts a similar embodiment. However, the round channel 226 comprises a plurality of moveable elements 310, wherein moveable elements 310 are connected via one or more linking elements 315 which also keep the moveable elements 310 at a distance of each other. The linking element may be relatively inflexible. Yet, more in general FIG. 2e also schematically depicts an embodiment of the rotator element 1200.

FIG. 2f schematically depicts a further embodiment. A lighting device 100 as shown in FIG. 1 may also consist of two parts which may be rotatable relative to each other. For instance, a first part 221 may rotate relative to a second part 222. Especially, the latter part may include at least part of the mount 1200, such as at least a screw cap 201. The former part may in embodiments include e.g. a bulb. Especially, the weight of the first part is equal to or larger than of the second part. The first part 221 and the second part 222 are functionally coupled via the ratchet system 227. The ratchet system 227 may be chosen such that a movement of the movable element 310 in a direction of the first rotation direction will apply a torque on the second part 222 relative to the axis of rotation, when hitting the first end 217. This may lead to a force in the direction of the rotation direction at the first end 217, and thus a rotation in that direction. Due to the ratchet system 227, a force in the rotation direction at the second part is applied, leading to rotation into the socket. In the opposite direction, the first part may relatively freely rotate. Hence, the ratchet system may be configured such, that a torque on the first part relative to the axis or rotation may not lead to a substantial torque on the second part 222, and there is (essentially) no rotation out of the socket. In the ratchet system 227, barbs b and cartels c may be available, which elements facilitate the blocking in one rotation direction and allow rotation in the opposite direction.

When referring to FIG. 2f, a torus containing the bullets may be attached to the lighting device or may be part of the lighting device (the lighting device is not shown, only part of the first part and part of the second part. A hard collision can occur in both directions because the cap is essentially only rotating in one direction. The cap is attached to the inner ring with cartels. In case of a hard collision in the direction of rotation, both the remainder of the lighting device and the cap will be able to rotate a bit in that direction and the cap will thus further lock into the holder (turn into the socket), i.e. the direction of the inner arrow. The “ratchet” is such that one may turn the lighting device by turning the lighting device in the direction of the inner arrow (ratchet fixed). Undoing may not be done on the lighting device per se (see also below). Hence, if the lighting device gets a torque in the direction of the turn due to a hard collision, it is not transferred to the cap because the ratchet then passes/is not fixed (rotating cap). This means that the lighting device itself (not the cap) will then rotate (slightly) in the direction of the outer arrow. To turn the lighting device out of the socket, a further measure may have to be taken, such as fastening the ratchet with a knob or unscrewing the cap, etc.

The embodiment schematically depicted in FIG. 2f may also be seen as a combination of some features of FIGS. 2d and 2e, i.e. the combination of the ratchet system and multiple regions.

Note that in the ratchet systems as schematically depicted, the cartels and barbs may be exchanged, i.e. the barbs b (or other elements), and the cartels c (or other elements) may also be exchanged.

FIGS. 2a-2b schematically show embodiments wherein the movement is a rotation of the movable element, and FIGS. 2c-2f schematically show embodiments wherein the movement is a translation.

The term “plurality” refers to two or more.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in embodiments refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention also provides a control system that may control the apparatus or device or system, or that may execute the herein described method or process. Yet further, the invention also provides a computer program product, when running on a computer which is functionally coupled to or comprised by the apparatus or device or system, controls one or more controllable elements of such apparatus or device or system.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lighting device comprising (i) a rotator element that is rotatable in a first direction and a rotation-based mount which is configured to be mounted in a matching socket via a rotation in the first rotation direction of the rotation-based mount in the matching socket, wherein the rotator element comprises movable element which is at least movable in a plane parallel to the first rotation direction, wherein the movable element is configured to exert a torque on the rotator element with respect to an axis of rotation in the same direction as the first rotation direction when a vibration in a plane parallel to the first rotation direction is applied to the rotator element.

2. The lighting device according to claim 1, wherein the movable element is attached to a rotator element part with a movable arm.

3. The lighting device according to claim 2, wherein the movable arm is flexible.

4. The lighting device according to claim 2, wherein a weight of the movable element is at least 5 times a weight of the movable arm.

5. The lighting device according to claim 2, wherein the rotator element further comprises a stop element rigidly associated with the rotator element part and configured at a position that when the movable element is subjected to a force in a direction of the first rotation direction, the movable element will exert a torque with respect to the axis of rotation on the stop element.

6. The lighting device according to claim 5, wherein the moveable element and the movable arm are configured such that when the movable element is subjected to a force in a counter direction of the first rotation direction, the movable element will exert a force perpendicular to the axis of rotation, configured perpendicular to a plane parallel to the first rotation direction, or wherein the rotator element further comprises a flexible stop element rigidly associated with the rotator element part and configured at a position that when the movable element is subjected to a force in a counter direction of the first rotation direction, the movable element will exert a force on the flexible stop element.

7. The lighting device according to claim 1, wherein the rotator element comprises a channel wherein the movable element can move in the first rotation direction and in a counter direction, wherein the channel has (i) a first end, wherein when the movable element moves in a direction of the first rotation direction, the movable element moves in the direction of the first end, and (ii) a second end, wherein when the movable element moves in a counter direction of the first rotation direction, the movable element moves in the direction of the second end, wherein the second end further comprises a flexible stop element.

8. The lighting device according to claim 1, wherein the moveable element comprises a ball.

9. The lighting device according to claim 1, comprising the axis of rotation configured perpendicular to a plane parallel to the first rotation direction, wherein the rotator element comprises at least n movable elements, wherein the rotator element comprises n regions each comprising at least one of the movable elements, wherein the n regions are rotationally symmetrically distributed around the axis of rotation, and wherein n is selected from the range of 3-4.

10. The lighting device according to claim 1, comprising the an axis of rotation configured perpendicular to a plane parallel to the first rotation direction, wherein the rotator element comprises a round channel configured rotationally symmetrically around the axis of rotation, wherein the round channel and the moveable element comprises a ratchet system configured to hinder movement of the movable element in a direction of the first rotation direction and configured to allow movement of the movable element in a counter direction to the first rotation direction, wherein the round channel comprises a plurality of moveable elements, wherein moveable elements are connected via one or more flexible linking elements which also keep the moveable elements at a distance of each other.

11. The lighting device according to claim 10, wherein the lighting device comprises a first part and a second part, wherein the first part and the second part are functionally coupled via the ratchet system, and wherein the first part is rotatable relative to the second part.

12. The lighting device according to claim 1, wherein the rotation-based mount comprises the rotator element.

13. The lighting device according to claim 12, wherein the rotator element is configured within a screw cap of the lighting device.

14. The lighting device according to claim 1, wherein the lighting device comprises the rotation-based mount, a light transmissive envelope, and a carrier part, wherein the carrier part is functionally coupled to the rotation-based mount and the light transmissive envelope, wherein the carrier part comprises the rotator element.

15. A lighting system comprising one or more of a lamp and a luminaire comprising the lighting device according to claim 1, and a socket matching a rotation-based mount of the lighting device, wherein the rotation-based mount is hosted by the socket.
